(19) United States
(12) Patent Application Publication
(10) Pub. No.: US 2023/0413003 A1
(43) Pub. Date: Dec. 21, 2023

(54) AUDIO PROCESSING IN A VIRTUAL ENVIRONMENT

(71) Applicant: Adept Reality LLC, New York, NY (US)

(72) Inventors: David John Smith, Morristown, NJ (US); Brennan McTernan, Fanwood, NJ (US)

(21) Appl. No.: 17/841,258

(22) Filed: Jun. 15, 2022

(51) Int. Cl. H04S 7/00

(52) U.S. Cl. CPC H04S 7/303; H04S 2400/13; H04S 2400/11

(57) ABSTRACT

The various systems and methods disclosed herein provide an enhanced audio experience in a virtual environment. In some implementations of the system and method for enhancing audio, a user forms a group with one or more desired audio sources in a virtual environment, and audio coming from sources outside of the group are filtered to become less obtrusive. In some implementations, causing non-group audio to become less obtrusive is accomplished by lowering its perceived volume.

### FIELD OF THE DISCLOSURE

The present disclosure relates to the field of audio processing in virtual environments, and more particularly the creation and handling of audio groups in a virtual environment.

### BACKGROUND

Virtual environments generally aim to present digital content in a format that simulates realistic audio and visual cues. In most cases, this realistic depiction is desirable to create a more immersive experience to a user. However, there are certain scenarios where altering sensory stimuli away from a realistic presentation creates a more preferable experience.

One such scenario arises in the context of conversations in a typical multi-user, virtual environment. In this example scenario, users are presented as avatars occupying a three-dimensional volume; however, when the avatars transmit audio they act as point sound sources within the environment. When a user is trying to identify or focus on audio from a primary source (e.g., an individual or group in the environment), audio from secondary sound sources around the user can interfere with the user's ability to clearly discern audio from the primary source. Sounds coming from all directions in the environment can be both distracting and aggravating when trying to focus on a single source, diminishing the quality of the user experience.

In a real-world analogue, such as at a party with multiple audio sources (people, music, television, etc.), listeners are able to focus on a primary conversation of interest in the midst of secondary audio streams present all around them. This so-called “cocktail party effect” relies on an individual's ability to tune-out extraneous noise with the assistance of sophisticated binaural localization techniques, and individual signal-to-noise ratio optimizations at the ears impacted by the listener's specific body geometry, including the head, torso, and ears. These criteria form part of an individualized head-related transfer function (HRTF), which can differ greatly from person to person. In addition to listener-based audio cues, lip reading, body language, familiarity, and context also help one's brain to isolate particular speech in a noisy environment.

While virtual environments are always improving, the level of detail in both the acoustic qualities of the synthesized sound and the subtleties of the visual presentation make it difficult for a user to utilize real-world means of isolating speech in the presence of a distracting environment. Therefore, a sound processing technique is needed to enhance audio intelligibility from a primary source in noisy virtual environments.

### SUMMARY

The various systems and methods disclosed herein provide for an enhanced virtual experience within a virtual environment. In some implementations, the system and methods disclosed herein provide an enhanced audio experience for users navigating avatars within a virtual environment. In some implementations, a system of one or more computers can be configured to perform particular operations or actions by virtue of having software, firmware, hardware, or a combination of them installed on the system that in operation causes or cause the system to perform virtual environment enhancements will be described. One or more computer programs can be configured to perform particular operations or actions by virtue of including instructions that, when executed by data processing apparatus, cause the apparatus to perform the enhancement actions. One general aspect includes a method of audio processing in a multi-user virtual environment having a plurality of audio sources. The method of audio processing also includes determining a group status of a user; receiving an audio object at the user; classifying the received audio object as a primary audio object or a secondary audio object based upon the determined group status of the user; processing the received audio object at a first sound processor if classified as a primary audio object and at a second sound processor if classified as a secondary audio object, where the first sound processor applies a first set of filters to audio objects processed therethrough, and the second sound processor applies a second set of filters to audio objects processed therethrough that are different from said first set of filters. Other embodiments of this aspect include corresponding computer systems, apparatus, and computer programs recorded on one or more computer storage devices, each configured to perform the actions of the methods.

Implementations may include one or more of the following features. The method where the group status of a user can be either grouped with a distinct group or ungrouped, and the step of classifying classifies all received audio objects as primary audio objects when the group status is ungrouped. The group status of a user can be either grouped with a distinct group, or ungrouped, and when the group status of the user is grouped, the step of classifying classifies received audio objects as primary audio objects if the audio objects come from audio sources that are members of the distinct group of the user, and classifies received audio objects as a secondary audio objects if the audio objects do not come from audio sources that are members of the distinct group of the user. The step of determining further may include the steps of: identifying an audio source within a focus area of a visual scene of the virtual environment presented to the user; evaluating a distance between a user's avatar within the virtual environment and the audio source within the virtual environment; grouping with the audio source into a distinct group; and setting a group status of the user to grouped and associated with the distinct group. The step of identifying includes calculating a dot product of a facing vector directed toward a facing direction of a user's avatar, and a source vector in a direction from the user's avatar to the audio source. The method may include the step of maintaining a grouped status by: calculating a common focal point at a geometric center of a plurality of members of a distinct group and a group perimeter encircling the plurality of members of the distinct group, verifying that the user's avatar is facing either the geometric center of the distinct group or a member of the distinct group. Verifying includes calculating a dot product of a facing vector directed toward a facing direction of the user's avatar, and a source vector in a direction from the user's avatar to the geometric center of the distinct group and each member of the distinct group. Implementations of the described techniques may include hardware, a method or process, or computer software on a computer-accessible medium

In some aspects, the techniques described herein relate to a system for processing audio in a virtual environment a virtual reality apparatus having a control unit, a sensory processing unit, and a non-transitory storage unit having instructions stored thereon that, when executed by the control unit and the sensory processing unit, causes the control unit and sensory processing unit to perform at least the following: determining a group status of a user; receiving an audio object at the user; classifying the received audio object as a primary audio object or a secondary audio object based upon the determined group status of the user; processing the received audio object at a first sound processor if classified as a primary audio object and at a second sound processor if classified as a secondary audio object, where the first sound processor applies a first set of filters to audio objects processed therethrough, and the second sound processor applies a second set of filters to audio objects processed therethrough that are different from said first set of filters. Other embodiments of this aspect include corresponding computer systems, apparatus, and computer programs recorded on one or more computer storage devices, each configured to perform the actions of the methods.

In yet some additional aspects, the techniques described herein relate to a method of processing audio in a virtual environment may include the steps of: defining a group status of a user; receiving group status and audio output data of an audio object coming from an audio source, where the audio output data includes default audio output parameters; comparing object class data of the audio object with object class data of the user; calculating, at a first sound processor with a first filter, filtered audio output parameters of the audio output data of audio objects having the same object class data as the user; calculating, at a second sound processor with a second filter, filtered audio output parameters of the audio output data of audio objects not having the same object class data of the user; and transmitting the audio output data with filtered audio output parameters to an audio output device. Other embodiments of this aspect include corresponding computer systems, apparatus, and computer programs recorded on one or more computer storage devices, each configured to perform the actions of the methods.

Implementations may include one or more of the following features. The method where the step of defining includes the steps of: identifying whether an audio source is within a focus area of the user, determining whether the user is within a join distance of an audio source within the focus area of the user, joining with the audio source into a primary group, and altering the group status of the user to include a grouped status associated with the primary group. The default audio output parameters include a default volume level, and where the second filter produces filtered audio output parameters having a lowered volume level.

As described above and set forth in greater detail below, systems in accordance with aspects of the present disclosure provide a specialized computing device integrating non-generic hardware and software that improve upon the existing technology of human-computer interfaces in a virtual environment by providing unconventional functions, operations, and audio processing for generating interactive display and audio experience outputs in the virtual environment. The features of the system provide a practical implementation that improves the operation of the computing systems for their specialized purpose of providing audio processing in virtual environments, and more particularly the creation and handling of audio groups in a virtual environment. In some implementations, the use of directional vectors and dot product vector processing reduces the computational demands for audio processing thereby creating an enhanced audio experience for avatars interacting within the virtual environment.

### BRIEF DESCRIPTION OF THE DRAWINGS

FIG. 1A is an isometric view of an implementation of a virtual environment with various virtual objects portrayed therein.

FIG. 1B is a top view of the virtual environment of FIG. 1A with virtual objects represented by symbols that indicate various object features.

FIG. 2 is a schematic illustration of user interacting with a virtualization system through which some implementations may operate.

FIG. 3A is a schematic illustration of a visual scene of the virtual environment of FIG. 1 with a first field of view presented to a user through a virtualization system.

FIG. 3B is a schematic illustration of a visual scene of the virtual environment of FIG. 1 with a second field of view presented to a user through a virtualization system.

FIG. 4A is a schematic representation of an audio point source with a parabolic volume decay over distance.

FIG. 4B is a schematic representation of an audio point source with an area of constant volume and parabolic volume decay beyond the constant volume.

FIG. 4C is a schematic representation of an audio point source with a parabolic volume decay over distance with a longer decay in one direction than another.

FIG. 4D is a schematic representation of an audio point source with an area of constant volume and parabolic volume decay beyond the constant volume, with a parabolic volume decay over distance with a longer decay in one direction than another.

FIG. 4E is a schematic representation of an audio point source with an area of constant volume and an inverse square volume decay beyond the constant volume, with a sharp cutoff at a threshold volume.

FIG. 5 is a top view of the virtual environment of FIG. 1A with virtual audio objects represented by symbols that indicate various object features, including sound transmission areas.

FIG. 6 is a top view of a portion of the virtual environment of FIG. 1A comparing the relative distances of audio sources in the vicinity of a particular avatar.

FIG. 7 is a top view of a portion of the virtual environment of FIG. 1A comparing the relative angles of audio sources compared to a facing direction of a particular avatar.

FIG. 8 is a block diagram showing components of an illustrative system for implementing various implementations of the disclosure.

FIG. 9 is a block diagram showing example virtual environment server subcomponents of the illustrative system of FIG. 8.

FIG. 10 is a block diagram showing example sensory processing unit subcomponents of the illustrative system of FIG. 8.

FIG. 11 is a flowchart that illustrates some implementations of the system and method for delivery of audio to a user within a virtual environment.

FIG. 12 is a flowchart that illustrates some implementations of the system and method for updating the state of a virtual environment.

FIG. 13 is a flowchart that illustrates some implementations of a group forming process.

FIGS. 14A, 14B, and 14C illustrates some relative volume effects arising from some implementations of group forming methodology.

FIG. 15 is a flowchart that illustrates some implementations of the system and method for applying group filters when a user is part of a group.

FIGS. 16A-16F provide sequential schematic views of six avatars forming and leaving groups.

FIGS. 17A-17E illustrate group geometry changes as members join, move within, and leave a group.

FIG. 18 is a flowchart that provides an implementation of a group forming process.

### DETAILED DESCRIPTION

The disclosure herein provides various implementations of virtual audio processing systems and methods from which those skilled in the art shall appreciate various novel approaches and features developed by the inventors. These various novel approaches and features, as they may appear herein, may be used individually, or in combination with each other, as desired.

In particular, the implementations described, and references in the specification to “one implementation”, “an implementation”, “an example implementation”, etc., indicate that the implementation(s) described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, persons skilled in the art may implement such feature, structure, or characteristic in connection with other implementations whether or not explicitly described.

With respect to the various implementations described herein, the term “virtual environment” is meant to encompass any fully or partially simulated environment presented to a user, including virtual reality with its fully artificial environment, augmented reality presenting a real environment overlaid with virtual objects, and mixed reality presenting virtual interactive objects presented within a real environment.

Simulated environments typically involve digital presentation of a visual scene from a head mounted display but may also be projected onto a surface. The visual presentation can provide the same image to both eyes or different images to each eye to create a stereoscopic view, for example. Similarly, audio can be presented to a user through speakers, whether integrated into a head mounted display, through separate headphones, or through speakers within the real environment. In order to enhance the realism of the virtual environment, audio is typically presented to a user over multiple channels that are mixed to reflect the location of virtual objects within the environment. Alternatively, audio can be presented via a mono signal for location agnostic audio sources, such as an informational narration of virtual scenes. Increasingly, tactile feedback is also presented to a user through haptic devices in hand-held controllers, in a head mounted display, or external to the user. Tactile feedback can be presented in a position-based manner, much like audio. Specifically, tactile feedback may include vibration of one or more controllers, vibration of one or more actuators in a head mounted display, and movement of air from fans or ultrasonic devices, to name a few.

The following descriptions of the exemplary implementations are primarily in reference to a virtual reality environment for the sake of simplification, but does not limit the implementations to specific features of the exemplary virtual environment or user's hardware or software used to access such virtual environment.

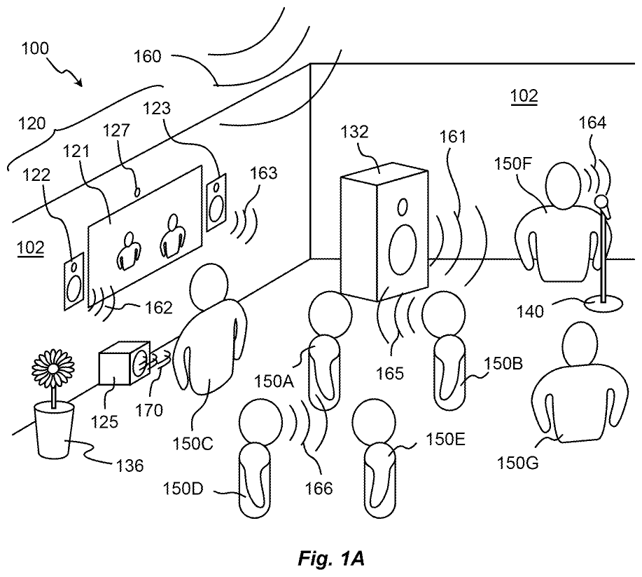

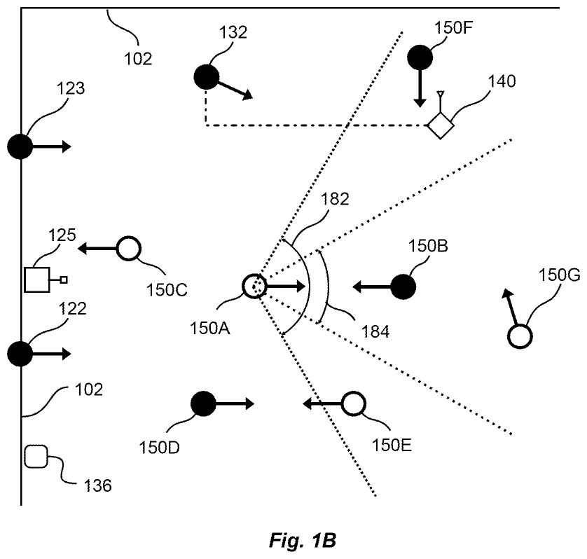

FIG. 1A is a perspective view of an example virtual environment 100. In the environment are various virtual objects configured with collision boundaries that place limits on a navigable space. Collision boundaries can encompass an entire virtual object, such as a shell around a solid object, can encompass discrete colliders representing parts of a virtual object, such as fingertips on a virtual hand or buttons on a virtual keyboard, or can define two-dimensional limits, such as boundaries 102 in virtual environment 100 acting to impede movement of a virtual object therethrough. These boundaries 102 may be represented as physical barriers such as walls or fences, or may be hidden boundaries that stay invisible to users, or which become visible only when closely approaching boundary 102. Boundaries 102 can further include features affecting audio, such as absorption qualities and reverberation qualities that can serve to affect perceived loudness of an audio object and aid in simulating acoustics of a room. While only labeled on wall-like structures in FIG. 1A, boundaries also include the floors, ceilings, or elements that impede movement within the environment, such as the decorative object 136.

In some implementations a virtual environment includes virtual audio/visual object sets, such as a multimedia entertainment system 120 that includes a virtual display 121 presenting a static or video image, left speaker 122 and right speaker 123 associated with respective left sound object 162 and right sound object 163, a subwoofer 125 that emanates tactile feedback 170, and a video capture device 127 that can record a scene of the virtual environment from the perspective of the device 127.

In some implementations, a virtual microphone 140 can be included in the environment 100 that captures an audio object from a nearby avatar and transmits it to an associated virtual loudspeaker 132 capable of reproducing that sound object therefrom. The reproduced sound from microphone 140 can include some transformation of the captured audio, such as increased volume, different volume decay characteristics, pitch/frequency shifting, distortion, voice changing, language translation, etc.

The environment 100 can be provided with one or more non-user audio sources, such as system messages, background music, or characters that are pre-loaded with information, music, movement paths, artificial intelligence routines, etc. These non-user audio sources can be associated with avatars or virtual objects with spatial audio that mimics real-world acoustic behavior or with altered acoustic behavior such as limiting reception distance or enhancing typical volume decays, or are presented as “voice of god” type system messages or background audio (represented as audio object 160) that are received at each listener with the same characteristics (volume, reverb, tone, etc.) at every point in the virtual environment. The environment 100 also includes avatars that represent users of the virtual environment 100. Avatars are able to navigate within the environment in a continuous manner, such as walking, or by space-jumping to a selected location within the environment.

Users can transmit and receive audio through their avatars. For example, in the environment 100, avatar 150A is listening to audio (represented as an audio object 165) from avatar 150B. In back of avatar 150A, avatar 150C is watching (on display 121), listening to (through speakers 122 and 123), and feeling (through subwoofer 125) sensory output of the entertainment system 120. Next to avatar 150A is avatar 150D engaged in conversation (audio object 166) with avatar 150E. Avatar 150G is looking at avatar 150F singing (via audio object 164) into a virtual microphone 140 that functions to broadcast the audio object 164 through the loudspeaker 132 as audio object 161. Each of the audio, visual, and haptic objects within the environment are processed as point sources for purposes of determining positions of audio objects and visual objects.

FIG. 1B is a top view of the virtual environment 100 of FIG. 1A with virtual objects at their respective locations represented by symbols that reflect various object features. Closed circles (150B, 150D, 150F, 122, 123, and 132) represent audio emitters, or sources that are actively transmitting a corresponding sound object. Open circles (150A, 150C, 150E, and 150G) represent avatars that are capable of but not presently transmitting a corresponding sound object. Other objects including microphone 140, subwoofer 125, and decoration 136 (as well as virtual display 121 and visual capture device 127 not represented in FIG. 1B) in the environment 100 are not capable of directly transmitting audio objects in this particular example environment and are represented by non-circular open shapes. Boundaries 102 may in some implementations be able to transmit audio objects at locations where avatars approach or cross the boundary 102 to alert a user of such approach or crossing. In addition to providing information regarding audio transmission, object symbols also indicate an object's orientation with arrows. Orientation can be relevant for both audio transmission and reception features, as described further below.

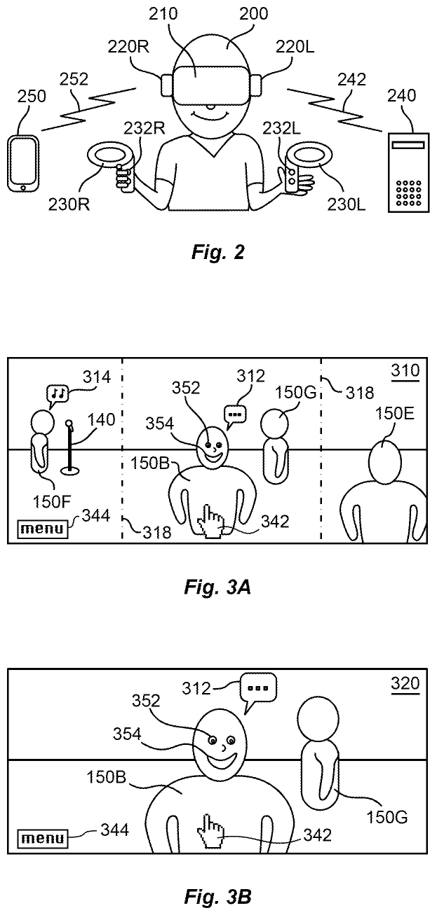

FIG. 2 illustrates how a user 200 can interact with a virtual environment. Virtual environments are most typically presented to users through their visual and aural senses. In some implementations, visual presentation is achieved through a head mounted display 210 that provides a slightly different image to each of the user's eyes, creating a sense of depth through stereoscopic parallax. Alternatively, a display placed far from a user's eyes may be used with or without the help of three-dimensional presentation techniques, such as 3D glasses. Similarly for audio, head mounted audio devices such as headphones or bone conducting devices can deliver different audio to each ear through, for example, a right audio source 220R and a left audio source 220L. Alternatively spatial audio can be delivered far from the user's ears through two or more speakers placed around (e.g., distanced away from) the user. Either way, in order to enhance realism of a virtual environment, multichannel audio presented to the user is synced with the visual presentation so as to anchor sounds to corresponding elements in the virtual environment. This alignment should persist as the visual scene presented to the user changes with movement of a user's avatar position or orientation.

A visual scene presented to a user can be updated without input from the user such as in a virtual tour or virtual ride (e.g., a rollercoaster), or by receiving movement input from the user to manipulate the user's position and orientation with the virtual environment. For example, in some implementations a virtual environment system may track a user's movements within a real environment through motion capture systems, including inertial systems with sensors such as gyroscopes, magnetometers, and accelerometers attached at one or more positions on a user's body, or optical systems using cameras or time-of-flight sensors that track markers on or features of the user in relation to another position (the environment, other markers, the camera location, etc.). The cameras or time-of-flight sensors can be located at one or more positions within the real environment, or attached to a user's body, such as being integrated into a head mounted display to track movement through the real environment or motion of the user's hands and fingers to determine grasp and orientation. Alternatively, or in combination, the user can utilize one or more input devices such as controllers 230R and 230L having finger actuated controls 232R and 232L, respectively, (e.g., buttons, joysticks, trackpads, etc.) to move a user's avatar through a virtual environment. Controllers 230R and 230L can also include motion tracking sensors to track a user's arm or body movements that can be reflected on their avatar in the virtual environment.

As the visual scene is updated, the audio scene must also be updated to enhance the realism and immersion of the virtual environment. The computation required to render a synchronized audio-visual presentation can be done fully on board the head mounted display 210, or can utilize external devices such as a mobile device 250 or computing device 240. The mobile device 250 and computing device 240 can provide data links 252 and 242, respectively, through a wireless connection such as Bluetooth or wi-fi, hard-wired through cabling, or a combination of wireless and wired technologies. Computing device 240 can be a local computing device, a hosted server accessed over a network, or both.

The presentation of visual and audio scenes depends on system or user settings regarding a user's field of view of the virtual environment. FIG. 1B shows two alternative fields of view for the user of avatar 150A, including a wide field of 182 of approximately 120 degrees and a narrower field of view 184 of approximately 60 degrees. FIG. 3A shows a visual scene 310 utilizing the wide field of view 182. The wide angle allows a user to see avatars 150F, 150B, 150G, and 150E. In some implementations the visual scene 310 includes a pointer 342 that is manipulated by the user, and a selectable menu button 344 providing various functionality for interacting with the visual scene 310. The visual scene 310 may also show information regarding other avatars in the visual scene, such as a speech bubble 314 over avatar 150F indicating that the avatar 150F is transmitting audio over a loudspeaker (in this case loudspeaker 132) and speech bubble 312 over avatar 150B indicating that the avatar 150B is transmitting local audio. Avatar 150B may also include dynamic facial features such as eyes 352 and a mouth 354 to provide additional details about the avatar, such as mood, lip movements while speaking, gaze, etc.

FIG. 3B shows a visual scene 320 utilizing the narrow field of view 184. The narrow angle allows a user to see only avatars 150B and 150G. This narrower field of view is represented in FIG. 3A by dashed lines 318, comprising a central area of the visual scene 310. In order to maintain realism, a chosen field of view should present a visual scene where perspective and the perceived angles between displayed objects is realistically spatially accurate.

Referring back to FIG. 1B, a system rendering a virtual environment will render an audio scene based on the features of audio objects (both emitters and listeners) within the environment. Audio sources in a virtual environment appear to emanate sound from a single point. While this sound can emanate symmetrically in all direction from the point source, some audio may be more directional, based on the facing direction of the source. In some implementations, the perceived volume of the audio coming from the point source is primarily a factor of the distance a listener is from the source, dropping from a reference volume at the source to a minimum level at some predetermined distance from the source. The rate that the volume drops off over that distance shall be referred to herein as a “volume decay.”

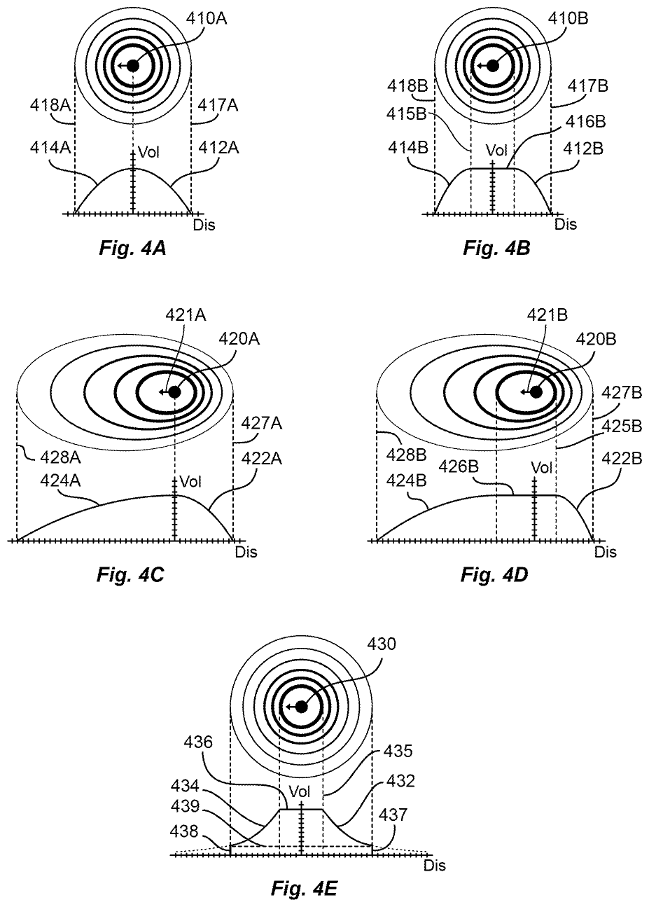

FIGS. 4A-4E present various ways the volume decay of audio can be presented as a factor of distance from a point source representation of an audio source. FIG. 4A is a schematic representation of an audio point source 410A with a parabolic volume decay 412A and 414A over distance. The decay is symmetric in all directions which presents a circular decay pattern when viewed from the top (represented above the volume decay curves 412A/414A). The volume of the decay reaches zero at cutoff distances 417A and 418A.

FIG. 4B is a schematic representation of an audio point source 410B with an area of constant volume 416B and a symmetric parabolic volume decay 412B and 414B beyond the constant volume 416B. The constant volume section 416B provides for equal volumes at another user when they are within a threshold distance 415B from the point source 410B. The volume of the decay reaches zero at cutoff distances 417B and 418B.

FIG. 4C is a schematic representation of an audio point source 420A with an asymmetric parabolic volume decay over distance with a longer decay 424A in one direction than a shorter decay 422A in the other. As seen from above, the decay pattern is substantially elliptical with the point source 420A at a focus point of the ellipse and another focus point in the facing direction 421A. This means that sound will project farther in the direction of the facing direction 421A than in the opposite direction. The volume of the decay reaches zero at cutoff distances 427A and 428A.

FIG. 4D is a schematic representation of an audio point source with an area of constant volume 426B and parabolic volume decay beyond the constant volume 426B, with a parabolic volume decay over distance with a longer decay 424B in facing direction 421B and a shorter decay 422B in the other. The constant volume section 426B provides for equal volumes at another user when they are within a threshold distance 425B from the point source 420B. The volume of the decay reaches zero at cutoff distances 427B and 428B.

FIG. 4E is a schematic representation of an audio point source 430 with an area of constant volume 436 and a symmetric inverse square volume decay 432 and 434 on either side of the constant volume 436, with a sharp cutoff at distance 437 and 438 representing a threshold volume 439 when within threshold distance 435. In some implementations, the sharp cutoff is used for inverse square decays that are asymptotic to a zero volume and would cause unnecessary volume calculations for long distances. In other implementations an inverse square volume decay can be shifted down along the volume axis to be asymptotic to a negative value, thereby having a zero volume where the curve crosses at a desired distance.

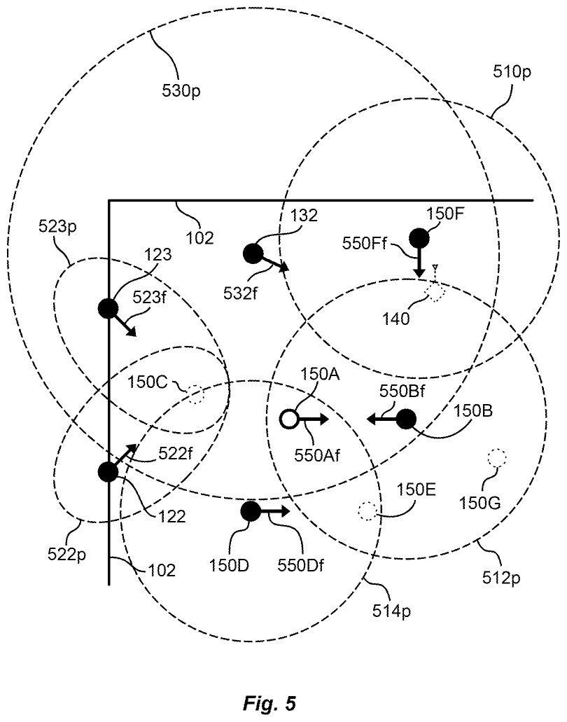

FIG. 5 a top view of the virtual environment 100 of FIG. 1A displaying virtual audio objects with their respective transmission limits (corresponding to cutoff distances of FIGS. 4A-4E). In some implementations a user represented by avatar 150A is primarily interested in the audio transmitted by avatar 150B. However, there are five other audio sources transmitting audio in this environment. Each audio source has a respective reference volume at the point source, and emanates a loudness decay profile radially therefrom. In some implementations avatars 150B, 150D, and 150F exhibit a symmetric inverse square volume decay such as that described in reference to FIG. 4E, with a maximum default volume 436, as provided above in relation to FIG. 4E. The maximum default transmission distance for each of the transmitting avatars 150B, 150D, and 150F is represented by transmission limits 512p, 514p, and 510p, respectively, correlating to the default cutoff distances 437 and 438, as illustrated above in relation to FIG. 4E.

In some implementations, loudspeaker 132 exhibits a different volume decay curve than avatars 150B, 150D, and 150F, such as having a louder reference volume and covering more area than the avatars. In some implementations the audio transmitted by avatar 150F and received at microphone 140 is transmitted from the location of the loudspeaker 132, which amplifies the volume of the audio, and changes the volume decay of the audio, such as exhibiting the symmetrical volume decay of FIG. 4A, where default transmission limit 530p of loudspeaker 132 occurs at a distance where the volume drops to zero.

In some implementations, speakers 122 and 123 of the entertainment system 120 (shown in FIG. 1A) provide more focused audio and overlap at a “sweet spot” area (in which area avatar 150C is located). In some implementations the volume decay can resemble that of FIG. 4 where the volume decay goes to zero along substantially elliptical default transmission limits 522p and 523p with an elongation in the respective facing direction 522f and 523f of the speakers 122 and 123.

In some implementations, reverberation of audio signals off physical objects and boundaries can be additive to the respective signals, thereby amplifying the sounds. While such a transformation would potentially be more realistic and immersive, reverberation shall not be explored as a modifying factor for the purposes of this illustrative example of some implementations described herein.

For audio sources having volume decays that are radially symmetric, such as loudspeaker 132 and avatars 150B, 150D and 150F, the direction an audio source is facing (532f, 550Bf, 550Df and 550Ff, respectively) does not affect the perceived volume of a listener at a set radius from the audio source regardless of the angular direction of the listener with respect to a facing direction. In some implementations, volume can remain constant in a radial direction, but other features such as tone or reverberation can be altered to correspond to the facing direction of an audio source.

As shown in FIG. 5, avatar 150A is located within the transmission limits of three out of the five audio sources, namely the transmission limit 512p of avatar 150B (the interested audio source), the transmission limit 514p of avatar 150D, and the transmission limit 530p of loudspeaker 132. The audio of speakers 122 and 123, as well as the audio from avatar 150F cannot be heard from the listening position of avatar 150A under the default conditions provided above. The volume at avatar 150A of the audio signals transmitted by avatars 150B, 150D, and loudspeaker 132 are each a factor of the respective distances from the audio source positions to the listening position.

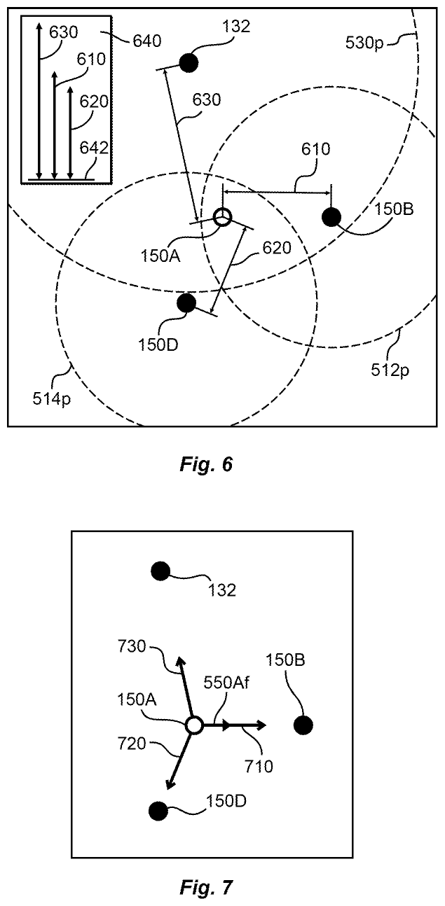

FIG. 6 simplifies the virtual environment of FIG. 5 to the three audio sources 150B, 150D and 132 with respective transmission limits 512p, 514p, and 530p overlapping avatar 150A. FIG. 6 identifies distance 610 between avatar 150A and 150B, distance 620 between avatar 150A and avatar 150D, and distance 630 between avatar 150A and loudspeaker 132, and compares the value of those distances in chart 640 where one end of each is aligned with line 642. As can be seen in chart 640, the distance represented by line 610 is between that of lines 620 and 630. As mentioned above, volume at a listening position is primarily a factor of distance from an audio source. Because the audio from avatars 150B and 150D have been described as having the same volume decay profile, the audio from avatar 150D would appear louder than that of avatar 150B at the listening position of avatar 150A as 150D is closer to avatar 150A than avatar 150B. Regarding the audio from loudspeaker 132, while the distance 630 is greater than that of the distance 610 of avatar B, the different reference volume and volume decay profile of loudspeaker 132 is such that the volume of the audio at distance 630 from the loudspeaker may be more than, less than or equal to the volume of the audio at a distance 620 from avatar 150D. For purposes of this example implementation, we will assume the volumes of audio from avatar 150D and loudspeaker 132 are equal at the listening position of avatar 150A. As such, while the user of avatar 150A is primarily interested in the audio from avatar 150B, under the above default audio conditions, the audio from avatar 150D and loudspeaker 132 could overpower the audio of avatar 150B that the user hears through their audio output equipment (e.g., headphones), diminishing the quality of the experience of the user.

In some implementations, a system and method may be employed to filter the volume from audio of interest to a user at a particular time and place within the virtual environment (the “primary audio”) so that the primary audio will be heard more clearly than audio from secondary audio sources of lesser interest to the user (the “secondary audio”).

Mathematical tools may be employed to filter the volume of the audio transmitted from each audio source such that the quality, including volume and discernability, of the primary audio is high enough to overcome the audio masking effect of secondary audio. In other words, filters can be applied to increase the intelligibility of a primary audio source “signal” in relation to the “noise” of secondary audio sources acting to interfere with the primary source. This is done by increasing the quality of the primary audio, decreasing the quality of the secondary audio, or some combination thereof.

In some implementations, increasing the intelligibility of the primary audio source includes keeping the quality of the primary audio unchanged, while the interfering attributes of the secondary audio are reduced or otherwise modified to make the secondary audio less distracting. In some implementations this relies on reducing the volume of secondary audio.

In some implementations, in addition to the distances referred to in reference to FIG. 6 that relate to audio strength, the facing direction of a user's avatar can be used to determine the perceived volume of audio coming from an audio source. In some implementations, reducing the volume of secondary audio relies on the direction an avatar of a user is facing is compared to the direction from the user's avatar to an audio source. The greater the angle from the facing direction of the user's avatar, the more the volume of an audio source is decreased. FIG. 7 provides a top view of a portion of the virtual environment of FIG. 1A comparing the relative angles between the facing direction 550Af of avatar 150A and the directions of audio sources 150B, 150D and 132. In some implementations, the facing direction of an avatar and the direction of an audio source compared to the facing direction are each represented as unit vectors (that is, vectors having a length of 1). Note that the vectors shown in FIG. 7 are drawn to different scales for clarity but should each be considered unit vectors for mathematical purposes of this implementation.

In some implementations, audio coming from sources in front of a user's avatar is prioritized over audio coming from behind, as users are likely to face audio sources of interest. An evaluation of a dot product between a vector defined by the facing direction of an avatar (which will be referred to herein as the “facing vector”) and a vector defined by the direction of an audio source can be used (which will be referred to herein as the “source vector”), in some implementations, to selectively filter or selectively alter the volume or other characteristic of the audio at a user's avatar in the virtual environment.

The dot product of two vectors is the sum of the products of corresponding components of each vector, written a·b=(aₓ×bₓ)+(a_{y}×b_{y}). The result of this algebraic operation is a scalar value that decreases as the angle between the facing vector 550Af and a source vector increases. In some implementations, this value is used to lower the volume of audio sources proportionate to the angle between the facing direction and the audio source.

For the scenario of FIG. 7, avatar 150B is directly in front of the user's avatar 150A. That is, the angle between source vector 710 pointing from avatar 150A to avatar 150B and facing vector 550Af of avatar 150A is zero. When the angle between any two vectors is zero, the dot product of the vectors will be a maximum positive value, which is 1 for unit vectors of length 1. When vectors are at ninety degrees to one another, the dot product of those vectors is zero. Beyond ninety degrees to the facing vector, the dot product results in a negative number, with the minimum occurring at 180 degrees from the facing vector, which, for unit vectors, results in a minimum value of −1.

Referring back to FIG. 7, vector 720 pointing from avatar 150A to avatar 150D is separated from the facing vector 550Af by more than 90 degrees. The resulting dot product of source vector 720 and facing vector 550Af will be a negative value. Similarly, vector 730 pointing from avatar 150A to loudspeaker 132 is separated from the facing vector 550Af by more than 90 degrees, resulting in a negative dot product between the vectors.

In some implementations, the value of a dot product, represented by a value P, can be used by directly multiplying the dot product result to a respective original audio volume level Vₒ at the user's avatar 150A to determine the modified volume Vₘ, represented by equation

$${V}_{m} = {max}_{- 1 \leq P \leq 1} ( {V}_{o} \times P , 0 ) .$$

In this scenario, for negative numbers (i.e., for audio coming from a directional source greater than 90 degrees from the facing directions), the modified volume Vₘ will be zero. As can be appreciated, in one implementation, a rapid computational assessment of the dot product result between a facing vector and audio source vectors can be used to alter or attenuate (e.g., filter) the audio perceived by the avatar as emanating from audio sources at angles greater than 90 degrees from the facing direction.

Alternatively, in some implementations, a dot product can be used to modify a volume through a mathematical function dependent on the value of the dot product. For example, in some implementations, the value of a modified volume Vₘ of an original volume Vₒ can be represented using the value P of a dot product as Vₘ=V, (1+P)/(3−P), resulting in Vₘ=Vₒ when the facing vector is in the same direction as the source vector (P=1), and V=Vₒ/3 when the facing vector is perpendicular to the source vector (P=0), and Vₘ=0 when the facing vector is opposite the source vector (P=−1).

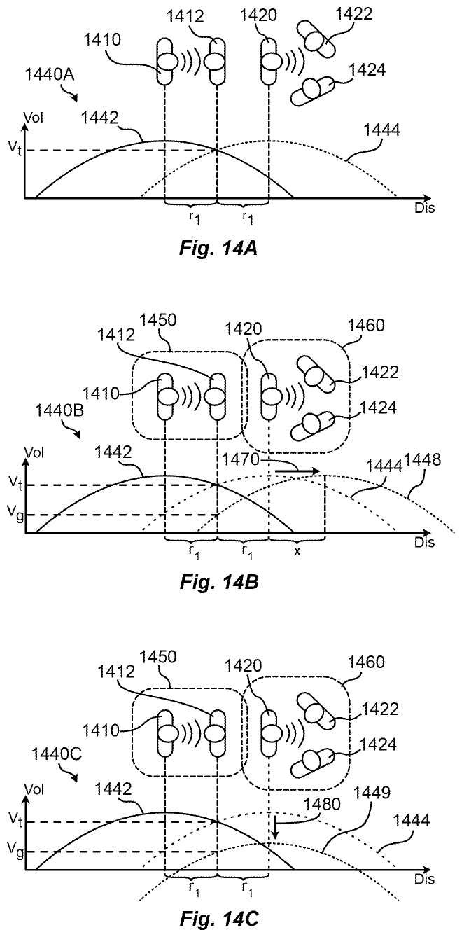

In some implementations the dot product can be used in an equation that shifts the volume decay curve away from a listening position along a distance axis (illustrated in FIG. 14B and described more fully hereinbelow). Shifting the volume decay curve to appear as though it comes from further away acts to simulate physically moving distracting audio sources away from the listening position, making it easier to hear the primary audio source. In some implementations the dot product can be used in an equation that shifts the volume decay curve of an audio source downward along a volume axis (illustrated in FIG. 14C and described more fully hereinbelow). Shifting the volume decay curve downward acts to simulate the secondary audio sources being transmitted less powerfully, which makes it easier to focus on the primary audio. In some implementations the dot product can be used in an equation that flattens the volume decay curve of an audio source downward along a volume axis. This acts to lower the power of the secondary audio but reduces the rate that the volume decays. In some implementations the dot product can be used in an equation that compresses the volume decay curve along a distance axis away from the listening position. This both increases the perceived distance of a secondary source as well as increases the rate that volume is reduced per unit distance. In some implementations the dot product can be used to apply a blurring filter to the respective audio, such as by blending the audio with white noise. Blurring audio makes it hard to understand contextually, which is less distracting, and softens the frequency overlaps that cause attenuation or amplifications of certain frequencies present in the primary and secondary audio sources. In some implementations the dot product can be used to apply a frequency shifting filter to the respective audio, such as by altering the default average frequency of the audio to be different from that of the primary audio. This change in average frequency may make the primary and secondary audio sound different enough so as to be able to distinguish between the two audio sources more easily.

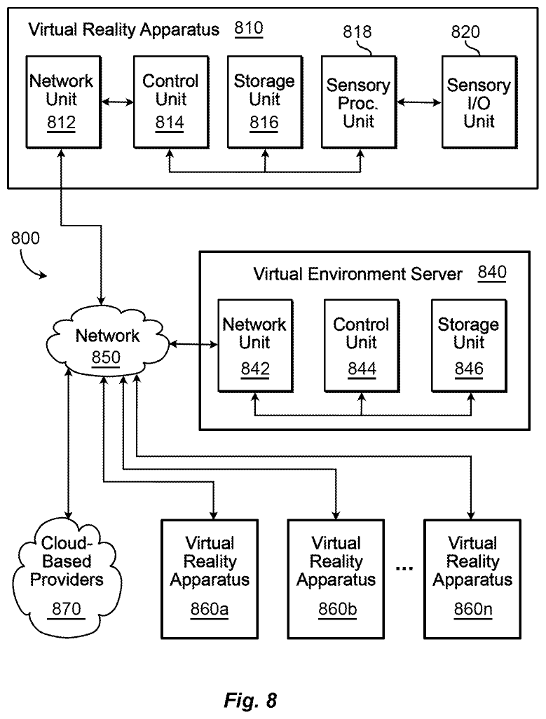

FIG. 8 illustrates a system 800 for providing a virtual environment to a user through virtual reality apparatus 810 (also referred to herein as “VR apparatus”). VR apparatus 810 includes a network unit 812 to communicate through network 850 with a virtual environment server 840 to update and render a virtual environment. VR apparatus 810 further includes a control unit 814 that accesses a storage unit 816 and a sensory processing unit 818. Sensory processing unit 818 uses instructions from the control unit 814 and data from the storage unit 816 to provide sensory output to a sensory input/output unit 820 (also referred to herein as “sensory I/O unit”). Sensory processing unit 818 further receives input from the sensory I/O unit 820 and updates the storage unit 816 and control unit 814 with the received input. In some implementations, sensory processing unit 818 is integrated with control unit 814.

The virtual environment server 840 receives updates from VR Apparatus 810 through its networking unit 842. The updates are processed by control unit 844 and storage unit 846 is updated with pertinent information regarding VR Apparatus 810. Virtual environment server 840 likewise communicates through network 850 with other multiple other VR apparatuses 860a, 860b and up to 860n, which may contain the same or similar elements of VR apparatus 810 to access the same or different virtual environment as that provided to VR apparatus 810. In some implementations, processing and data storage are provided by cloud-based third-party service providers 870, and can offload processing and storage from the virtual environment server 840 and VR apparatus 810/860n. Any reference to processing or storage on any device, including VR apparatus or servers described herein, should be interpreted to include cloud-based processing and storage performed by third parties to deliver a useful product to the devices.

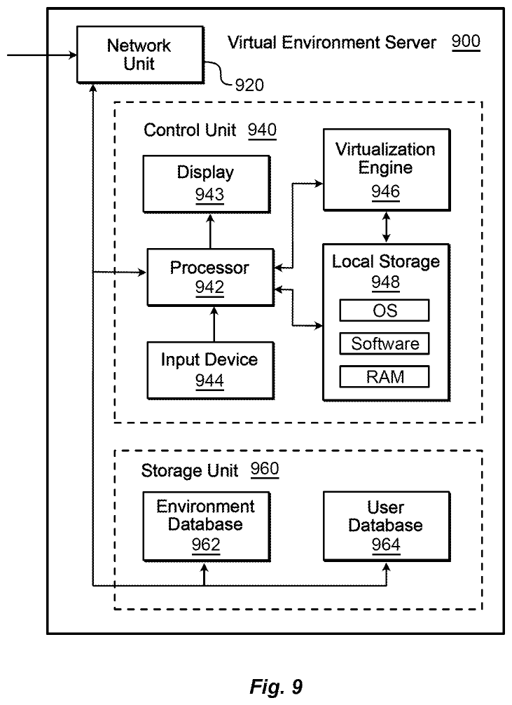

FIG. 9 illustrates one implementation of a virtual environment server 900 (e.g., one implementation of virtual environment server 840 of FIG. 8). Virtual environment server 900 is controlled by hardware and software subcomponents to enable VR apparatuses to access and to interact with a virtual environment. In some implementations, control unit 940 includes a processor 942 that uses local storage 948 to run software in an operating system environment, utilizing RAM and accessing storage unit 960 to manipulate data that is sent to virtualization engine 946 to build and update a virtual environment. Software is viewable on a display 943, and manipulatable via one or more input devices 944, such as a keyboard and mouse. Storage unit 960 includes an environment database 962 that stores data regarding non-user elements of a virtual environment, including layout, object functionality, default user settings, environment physics, etc. User database 964 stores data regarding specific users of the virtual environments created by the virtual environment server 900. This user data may include user details (e.g., identification information, age, location, contact information, account information, etc.), user preferences, avatars, inventories, payment information, etc. It should be appreciated that other user suitable data may be stored in other implementations. This information is used to render a user avatar in a virtual environment that is controlled, via network unit 920, by a user with a VR apparatus.

In some implementations, control unit 814 of VR apparatus 810 includes equivalent elements thereof as the control unit 940 of virtual environment server 900.

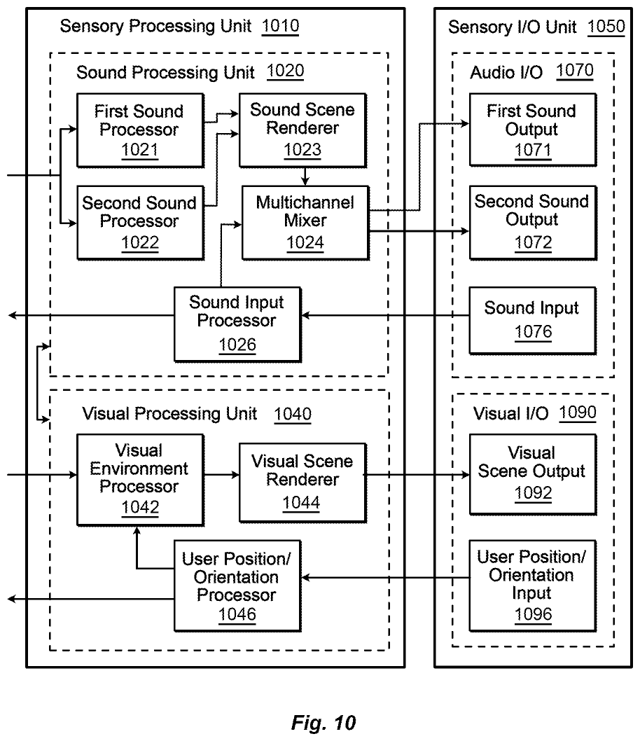

FIG. 10 is a block diagram showing example sensory processing unit subcomponents of the illustrative system of FIG. 8. FIG. 10 illustrates a sensory processing unit 1010, sensory I/O unit 1050, and their respective subcomponents according to some implementations of the system 800 of FIG. 8. Sensory processing unit 1010 includes a sound processing unit 1020 that processes sound data according to applicable rules and filters, such as those dot product filters described above. Audio object data processed by the sound processing unit 1020 have associated therewith identifying information, including from what audio source the associated audio object was transmitted, and the characteristics of that audio source that affect audio processing, such as a source classification (system-level source, background music source, member of a distinct group of sources, etc.) and default audio output parameters, including a default reference volume, default volume decay pattern, default average frequency modification, and default acoustic behavior, among others. Audio output data of audio objects processed by the sound processing unit 1020 is routed to either first sound processor 1021 or second sound processor 1022 based on identifying information associated therewith. First or second sound processors 1021/1022 then modify the audio output data according to first and second filters and processes, respectively, associated therewith. Modifications to the audio output data include adjustments from the default audio output parameters to affect the way the audio object is perceived within the virtual environment.

This modified audio output data is sent to a sound scene renderer 1023 to build a sound scene that matches the location of audio sources around the user's avatar with applicable visual objects within the virtual environment. The sound scene is then processed into separate audio streams by the multichannel mixer 1024 and sent through respective audio channels to first and second sound outputs 1071 and 1072 of audio I/O unit 1070 of sensory I/O unit 1050. Sound input 1076, such as one or more microphones, of audio I/O unit 1070 of sensory I/O unit 1050 captures audio from a user and sends that audio data, via sound input processor 1026 of sound processing unit 1020, to user database 964 of storage unit 960 of virtual environment server 900.

The location of visual objects that correspond with sound objects in the virtual environment is determined by visual processing unit 1040 using information from a user position/orientation processor 1046 as well as data stored in storage unit 816 of VR apparatus 810 or in storage unit 960 of virtual environment server 900. Data is requested by the visual processing unit 1040 (and the sound processing unit 1020) for the positional data and retrieved and delivered by the visual environment processor 1042, in some implementations further relying on control unit 840 of the virtual reality apparatus 810 to coordinate the retrieval and routing of the data. Visual processing unit 1040 uses this positional data to update the visual characteristics of the virtual environment, including the position and orientation of a user's avatar in the virtual environment. This information is then rendered for consumption by visual scene renderer 1044 that provides a visual scene viewable on visual scene output 1092 of visual I/O unit 1090 according to settings such as field of view, graphics resolution, etc. User position/orientation input 1096, such as controllers, head mounted display motion sensors, camera data, etc. is then provided to the visual processing unit 1040 to update the visual environment processor 1042, as well as storage unit 816 of VR apparatus 810 and user database 964 of storage unit 960 of virtual environment server 900.

An example implementation with application of the concepts and features described hereinabove will now be described. In some implementations of a virtual environment, a user's primary audio of interest may arise from a single audio source or a group of audio sources (e.g., avatars) engaging in a conversation. With groups of 3 or more avatars, it is common for an avatar to be facing other than directly at an avatar contributing to a group conversation. In order to avoid attenuating the volume of a group member who may be outside of a user's visible scene, audio from members of a group is excluded from classification as a secondary audio source.

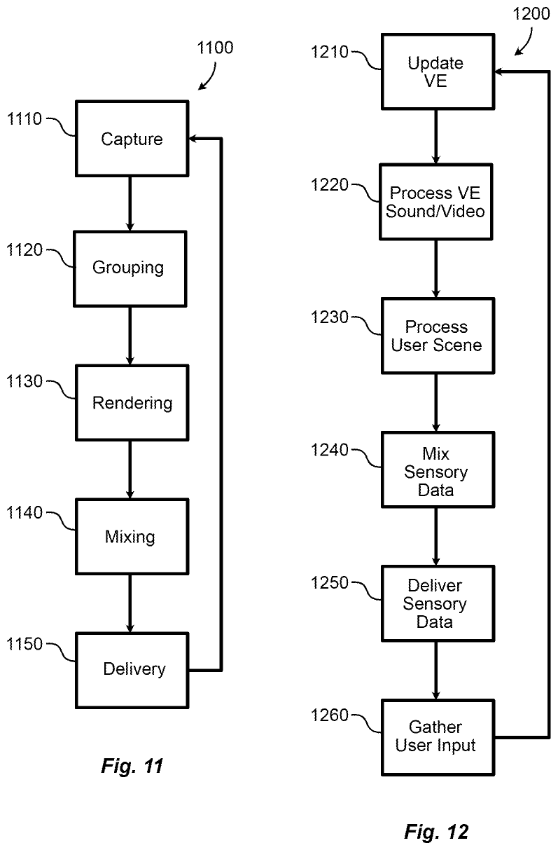

FIG. 11 is a flowchart that illustrates some implementations of the system and method 1100 for delivery of audio to a user within a virtual environment. The first block 1110 involves capturing audio from an audio source and storing the audio in the virtual environment server 900 with information about the source, such as the audio source's group status. The stored audio, along with associated visual data, is accessed by and delivered to VR apparatus 810 when rendering a virtual environment at a sensory processing unit 818.

At block 1120, the status of the user's membership in a group is retrieved. If the group status of the user is Ungrouped, the received audio is considered primary audio and is sent through a first sound processor 1021 of sound processing unit 1020. First sound processor 1021 applies a first set of filters to the audio. If a Grouped status is present for the user, the group status of the retrieved audio is compared to the user's group status, and if they are both Grouped in the same distinct group, the audio is considered primary audio and is sent through a first sound processor 1021. In some implementations, first sound processor 1021 can process the primary audio “normally” for a group, such as through realistic spatial audio filters for directional audio. If the retrieved audio is not grouped in the same distinct group as the user, the audio is considered secondary audio and is sent through second sound processor 1022. In some implementations, second sound processor 1023 processes the secondary audio “abnormally” for those outside of a group, such as by filtering audio to have lower than normal volume.

Once the audio is filtered, its filtered form then proceeds through the blocks of rendering 1130 (e.g., associating processed audio with physical locations), mixing 1140 (e.g., where audio from multiple sources may be combined and apportioned to multiple audio channels), and delivery 1150 the mixed audio to audio outputs 1071 and 1072 of the sensory I/O unit 1050. Once delivery of this audio is complete the method 1100 restarts and processes the next frame of audio information.

FIG. 12 is a flowchart that illustrates some implementations of the system and method for updating the state of the virtual environment for each visual and audio frame (or other update interval). Method 1200 begins at block 1210 with updating a virtual environment data at the virtual environment server 840. This involves control unit 842 requesting an update from each network-connected VR apparatus and storing the updates to the appropriate database in storage unit 960. Each VR apparatus 810/860n requests the updated virtual environment state from the virtual environment server 840, and the control unit 844 retrieves and routes the updated data regarding any changes to the virtual environment to the requesting VR apparatus 810/860n.

At block 1220, the sensory processing unit 1010 of VR apparatus 810 uses data retrieved from the virtual environment server 840 and stored in storage unit 816 to process the new environment in terms of the location of the visual and sound objects within the environment. Visual processing unit 1040 applies visual parameters such as lighting, texture mapping, etc., for each visual object, and first and second sound processors 1021 and 1022 apply audio filters, adjust global volumes, etc. At block 1230, the updated virtual environment data and user avatar position/orientation data are used by the sensory processing unit 1010 to identify how the virtual environment is presented to the user, where the field of view is rendered with processed visual objects by visual scene renderer 1044, and audio objects are rendered with respect to the user avatar's position and orientation, that is, mapped to the updated locations of visual objects in the virtual environment both within and outside of the field of view, at the sound scene renderer 1023.

At block 1240 the multichannel mixer 1024 of the sound processing unit 1020 produces a single audio stream to be delivered for each of the multiple channels using the position/orientation of the user's avatar in relation to each of the rendered audio sources. For example, if the multichannel mixer receives one audio signal originating from an audio source to the left of the avatar, one from the right, and one directly in front of the avatar, the mixer 1024 may, in some implementations, mix the three signals into two channels, a left channel and a right channel, with audio from the left audio source presented at a higher volume than the right audio source in the left channel, the right audio source higher than the left audio source in the right channel, and the front audio source being split evenly between the left and right channels. Also at this block 1240, the visual scene created by visual scene renderer 1044 may be rendered into two or more visual channels as further described below.

At block 1250, the audio in the mixed sound scene is then diverted by the multichannel mixer 1024 to different audio channels of the audio I/O of the sensory I/O unit 1050, and the visual output is sent to the visual scene output 1092 of the visual I/O unit 1090, which may be a single or multiple video channels sent to one or more screens, projectors, etc. Once the user is presented with a new virtual environment scene, user input is collected by the sensory I/O unit at block 1260 for further processing back at block 1210.

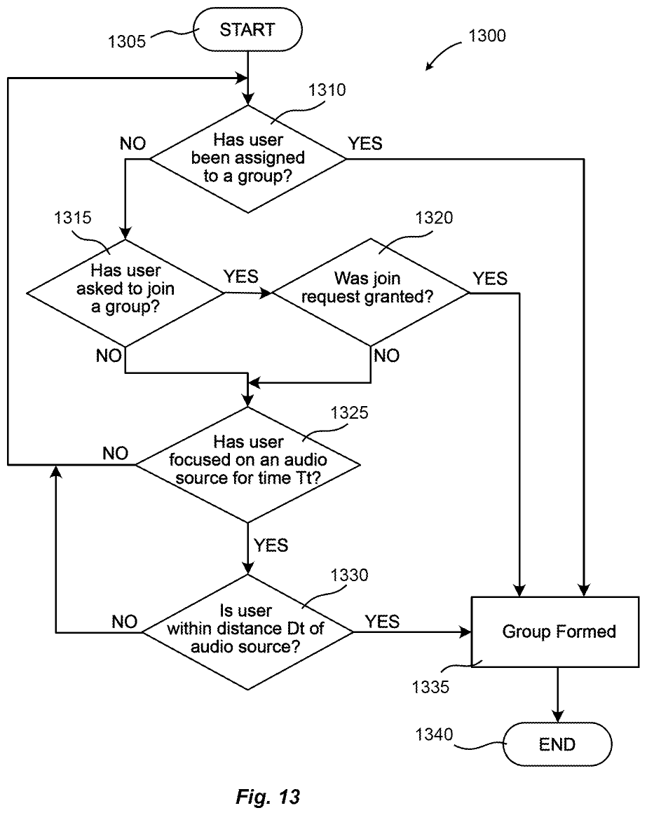

When analyzing grouping at block 1120 of method 1100, the user's group membership status determines to which sound processor the audio objects are routed. FIG. 13 provides a flowchart that illustrates some implementations of a group forming methodology 1300 to determine such membership status via different joining pathways. Method 1300 begins at block 1305 and proceeds as the stored user information is queried at 1310 to determine if the user has been assigned to a group. In some implementations, users may self-assign to a group by selecting to join a particular group. In some implementations, users may be assigned to groupings automatically by the system, or by another user or an administrator with the power to do so. When the user has been assigned to a group at block 1335, the process is ended at 1340, and the user status is updated and returned to the VR apparatus 810 and virtual environment server 840. When the user has not been assigned to a group, the system 800 is queried at 1315 to determine if the user has a pending join request. When a pending request is found, the system will wait for a predetermines length of time to determine whether the join request was granted. Once the wait time has passed and the join request is granted, the process flow confirms the user's group is formed at 1335, which will update a user's profile stored in the VR apparatus 810 and user database 964 to “Grouped” and associate the grouping with the other grouped audio source or sources, and the process terminates at block 1340.

When the answer to query 1320 is no, the process looks to user actions to determine group membership. At query 1325, the system 800 determines whether the user has focused on an audio source for a certain threshold amount of time, Tₜ. For example, in some implementations the visual scene renderer 1044 of visual processing unit 1040 determines what visual objects are to be rendered into a visual scene. A list of these items can be stored in VR apparatus 810 storage unit 816 and user database 964. This list can keep count of the number of frames (i.e., intervals between successive scene rendering operations, such as at step 1230 of process 1200) that visual objects remain within the visual scene, or within a subset of the visual scene, such as a narrower focus area of the field of view represented by the visual scene. One way to determine the location of an object within a visual scene is to perform a dot product of the user's avatar facing vector and the source vector of an audio source within the visual scene.

In addition to the algebraic definition of a dot product discussed above, the dot product can also be presented in relation to the following geometric definition, a·b=∥a∥∥b∥p cos θ, where ∥a∥&∥b∥ are the magnitudes of the vectors (which for unit vectors is 1), and θ is the angle between the facing vector and the source vector. In some implementations, the facing vector of a user's avatar will align with the center of its field of view (such as those seen in FIG. 1A), and an audio source will be within the field of view when the angle θ is less than half the angle of the field of view. For example, referring to FIGS. 3A the visual scene 310 corresponds to a roughly 120 degree field of view, with dashed lines 318 forming a central focus area corresponding to roughly 60 degree field of view (shown in FIG. 3B as visual scene 320). The maximum angle θ for which an audio source would be within the central area between lines 318 is half of that central area, corresponding to roughly 30 degrees. Therefore, in order to determine that an audio source is within the focus area, the dot product of a user's avatar facing vector (a) and the source vector (b) of an audio source must maintain a value such that a·b≤∥a∥∥ cos 30=(1)(1)(0.5)=0.5 (provided vectors a and b are unit vectors of magnitude 1).

When the user alters the avatar position or orientation such that an audio source is no longer within a focus area of the visual scene, or if the audio source leaves the scene, the counter for that source is reset. If no audio source within a focus area has exceeded the threshold time Tₜ at block 1325, the process returns to query 1310. If at block 1325 the system 800 determines that the frame counter for an audio source within the predetermined focus area has exceeded the threshold time Tₜ, the method 1300 proceeds to block 1330.

At query 1330 the system 800 determines whether an audio source that has remained within a focus area for time Tₜ is within a threshold distance Dₜ from the user's avatar. This information is calculated in some implementations by the visual scene renderer 1044 of visual processing unit 1040 (which also sends that information to sound scene renderer to determine a volume level at the user's avatar of the various audio sources within a sound scene). If the user's avatar is too far away (beyond threshold distance Dₜ) from the audio source the process will reset back to query 1310. If the avatar is within the threshold distance Dₜ, a group is formed, which will update a user's profile stored in the user database 964 to “Grouped” and associate the grouping with the qualifying audio source, and the process ends at block 1340.

FIGS. 14A, 14B, and 14C illustrate the effect of a user joining a group. FIG. 14A illustrates a scenario where the user represented by avatar 1412 desires to focus on audio from avatar 1410. Avatar 1410 is distance r₁ from avatar 1412, which corresponds on graph 1440A to a volume Vₜ on the volume decay curve 1442 (solid line) of audio from avatar 1410. Avatar 1420 in back of avatar 1412 speaking with avatars 1422 and 1424. The audio from avatar 1420 exhibits a volume decay curve 1444 (dotted line) having the same shape as volume decay curve 1442. Because avatar 1420 is also distance r₁ from avatar 1412, avatar's audio is also heard by the user of avatar 1412 at a volume Vₜ.

In some implementations, the audio received at avatar 1412 from 1420 may be modified by application of a dot product's scalar value as discussed previously. For example, because avatar 1420 is directly behind avatar 1412, the dot product of avatar 1412's facing vector and the source vector pointing to avatar 1420 would be the largest negative number possible (−1 for unit vectors). As such, under some implementations, the volume of the audio from avatar 1420 would be modified to have a zero volume value for direct application of the dot product (negative values rendered with volume). In some implementations, the dot product merely reduces audio for negative numbers. Either way, application of the dot product to the audio from avatar 1420 would result in reduced interference therefrom.

FIGS. 14B and 14C show scenarios similar to FIG. 14A, but with user's avatar 1412 and avatar 1410 together in a group 1450, and avatar 1420 in a group 1460 with avatars 1422 and 1424. Once a group is formed, the method 1200 will assign audio coming from non-group audio sources as secondary audio objects, and these secondary audio objects are processed through the second sound processor 1022 of sound processing unit 1020. The second sound processor 1022 applies certain filters to the secondary audio such that its interference is diminished at the user's avatar position.

Because avatar 1410 is in the same group as avatar 1412, avatar 1410's audio is routed through the first sound processor 1021 which, in some implementations, presents audio to the user at a default volume. In some implementations, the diminished interference comes in the form of shifting in direction 1470 by distance x the original volume decay curve 1444 (dashed line) of the audio of avatar 1420 to the position of volume decay curve 1448 (dotted line) as shown in graph 1440B of FIG. 14B. In some implementations, the diminished interference comes in the form of shifting the volume decay curve 1444 of the audio of avatar 1420 in direction 1480 to the position of volume decay curve 1448 as shown in graph 1440C of FIG. 14C. In both the transformations of original volume decay curve 1444, the shift causes the volume of avatar 1420's audio to be volume V_{g}, which is less than the unfiltered value Vₜ.

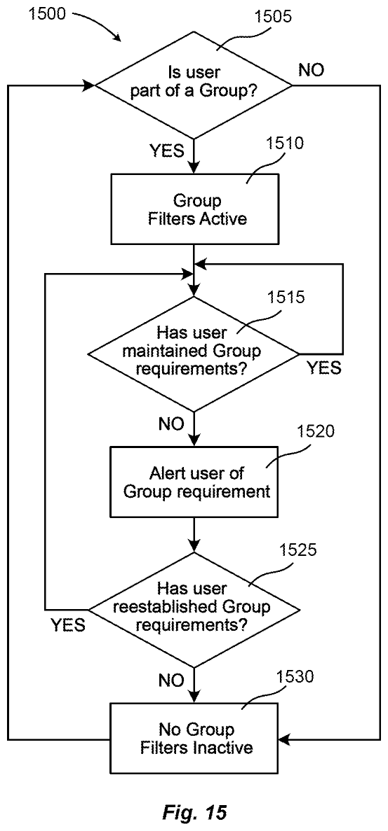

FIG. 15 depicts the process 1500 of applying and maintaining filters to secondary audio as performed in FIG. 14B. At query 1505, the system checks to see whether the user is a member of a group as determined, for example, by method 1300. If not, the process proceeds to block 1530 and audio is routed through the first sound processor 1021 that applies no group-related filters. When a group has been formed and group filters are active, non-group audio is processed at block 1510 through second sound processor 1022. Once applied, the process periodically queries at 1515 whether the user has maintained group status requirements. In some implementations, such group membership requirements include staying within a group threshold distance from a group center, where the group center is defined by the positional center of the group members' positions. In some example implementations, group requirements include the need for at least one group member to transmit an audio object during a threshold time period. In some implementations group requirements can include a maximum amount of time the user's visual scene does not include at least one group member's avatar. It should be appreciated that a group status maintenance requirement may include other suitable implementation dependent requirements. When a group member does not maintain a group requirement, the system will alert the user at block 1520, and wait a threshold time to allow the user to reestablish the group requirements. When the user does reestablish the group requirements, the process returns to query 1515. When the user does not reestablish group requirements, group filters are deactivated and all audio units will proceed through the first sound processor, and the process returns to query 1505.

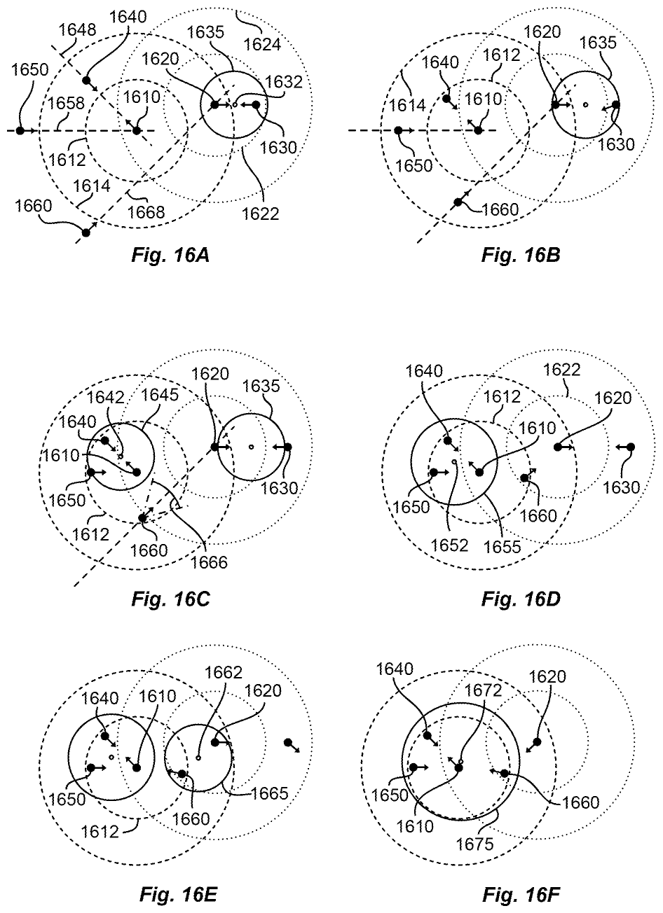

FIGS. 16A-16E provide sequential schematic views of six avatars forming and leaving groups. Referring to FIG. 16A, Avatar 1610 sits at the center of its associated audio perimeter 1614 and join perimeter 1612. Likewise, avatar 1620 sits at the center of audio perimeter 1624 and join perimeter 1622. Avatar 1620 is grouped with avatar 1630 within group perimeter 1635 with group center 1632. Avatar 1640 is within audio perimeter 1614 and moving along path 1648 towards avatar 1610. Avatar 1650 is moving along path 1658 towards avatar 1610, and avatar 1660 is moving along path 1668 towards avatar 1620.

In FIG. 16B avatar 1630 is shown to have moved away from avatar 1620 while remaining within group perimeter 1635. Avatar 1640 has moved within joining perimeter 1612 of avatar 1610, and avatars 1650 and 1660 have moved within audio perimeter 1614 of avatar 1610.

In FIG. 16C avatar 1640 has grouped with avatar 1610 around group center 1642 within group perimeter 1645. Avatars 1650 and 1660 have both moved within join perimeter 1612 of avatar 1610. Avatar 1650 is facing in the direction of avatar 1610 (i.e., within avatar 1650's field of view without regard to the field of view angle), however avatar 1660 does not have avatar 1610 within its field of view 1666. That is to say, the dot product of the facing vector of 1660 and the direction of a source vector toward avatar 1610 appears to be greater than a threshold value for cosθ, where θ is half of the total field of view angle. Meanwhile, avatar 1630 has moved further away from avatar 1620 such that, while still grouped with 1620, is now outside of group perimeter 1635.

As seen in in FIG. 16D avatars 1620 and 1630 are no longer grouped. Avatar 1650 has joined the group with 1640 and avatar 1610 around a new center 1652 with new perimeter 1655 which is larger than the perimeter 1645 to accommodate the additional member. Avatar 1660 has stopped at a point within join distance 1612 avatar 1610 as well as join distance 1622 of avatar 1620. However, as avatar 1660 is only facing avatar 1620 and not avatar 1610, avatar 1660 is set up to join into a group with 1620 only.

In FIG. 16E avatar 1660 did successfully form a group with avatar 1620 with group center 1662 and group perimeter 1665. Avatar 1660 has subsequently turned away from Avatar 1620 and group center 1662, and towards the group with avatars 1610 1640 and 1650. Turning away from avatar 1620 and group center 1662 initiates the process for leaving a group. Because avatar 1660 is still within join distance 1612 of avatar 1610, and is now facing avatar 1610, avatar 1660 meets the requirements necessary to join avatar 1610 in its respective group once it is no longer grouped elsewhere, as, in some implementations, avatars may only belong to one active group at a time.

In FIG. 16F avatar 1660 has ungrouped with avatar 1620 and has joined the group with avatars 1610 sixteen 40 and 1650, creating a new group center 1672 in new group perimeter 1675. Group perimeter 1675 has a larger radius then group perimeter 1655 to accommodate the additional member.

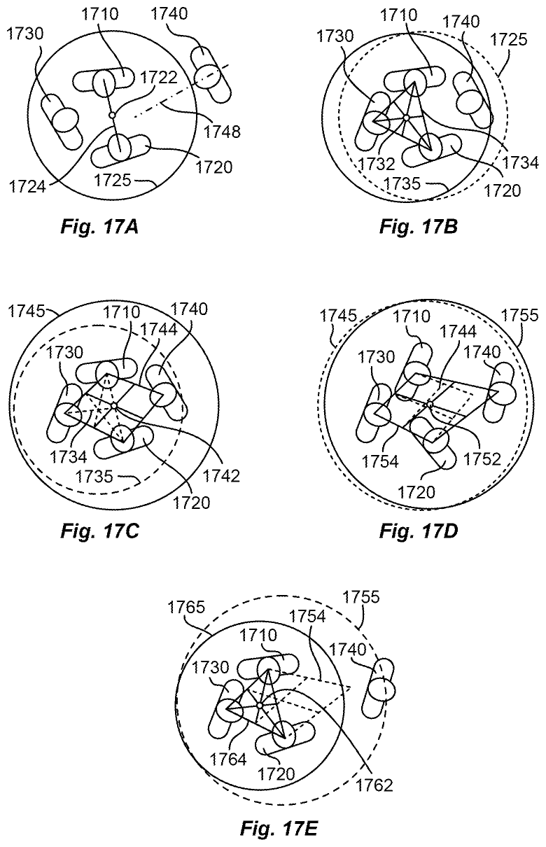

FIGS. 17A - 17E illustrate how, in some implementations, group centers and perimeters change as members join, move within, and leave the group. As illustrated in FIG. 17A, avatars 1710 and 1720 are in a group with group center 1722 and group perimeter 1725. Group center 1722 is calculated using group geometry 724 which in this case is align 1724 between avatar 1710 and 1720. Avatar 1730 Is within the requisite join distance in his facing a group member 1710, but has not yet joined the group. Avatar 1740 is moving along path 1748 towards the group of avatars 1710 and 1720.

In FIG. 17B avatar 1730 has joined the group with avatars 1710 and 1720, and a new group center 1732 is calculated based on group geometry 1734, which in this case is a triangle. Group perimeter 1735 is recalculated from the new group center 1732. In some implementations the radius of a group perimeter for three avatars may be the same as the radius for two avatars. In some implementations, the group perimeter radius may be proportionate to the number of group members for all group member sizes. Because the location of group center 1732 has shifted from previous group center 1722, the location of group perimeter 1735 has accordingly from previous group perimeter 1725. Avatar 1740 has now stopped within a join distance of one or more grouped members 1710, 1720, and 1730.

In FIG. 17C, avatar 1740 has joined the group. The previous group geometry 1734 and previous group perimeter 1735 are recalculated, and new group perimeter 1745 is created based on new group center 1742 of new group geometry 1744. The radius of new group perimeter 1745 is increased in some implementations to accommodate the new group size of four members.

In FIG. 17D avatar 1740 has turned and moved away from avatars 1710 seventeen 20 and 1730. Avatar 1740 is still grouped. Old group geometry 1744 is updated new geometry 1754 with new group center 1752. The shift in Group center causes a respective shift from the location of old group perimeter 1745 to new location of group perimeter 1755. While avatars 1710 and 1720 have changed their orientation as shown in FIG. 17D their positions remain the same and do not contribute to the altered new geometry 1754.

In FIG. 17E 1740 has left the group for failing to maintain group member requirements, which in some implementations includes continuing to face other group members or the group center. As such, previous group perimeter 1755 based on previous group geometry 1754 is updated to new group perimeter 1765 based on the group center 1762 of group geometry 1764.

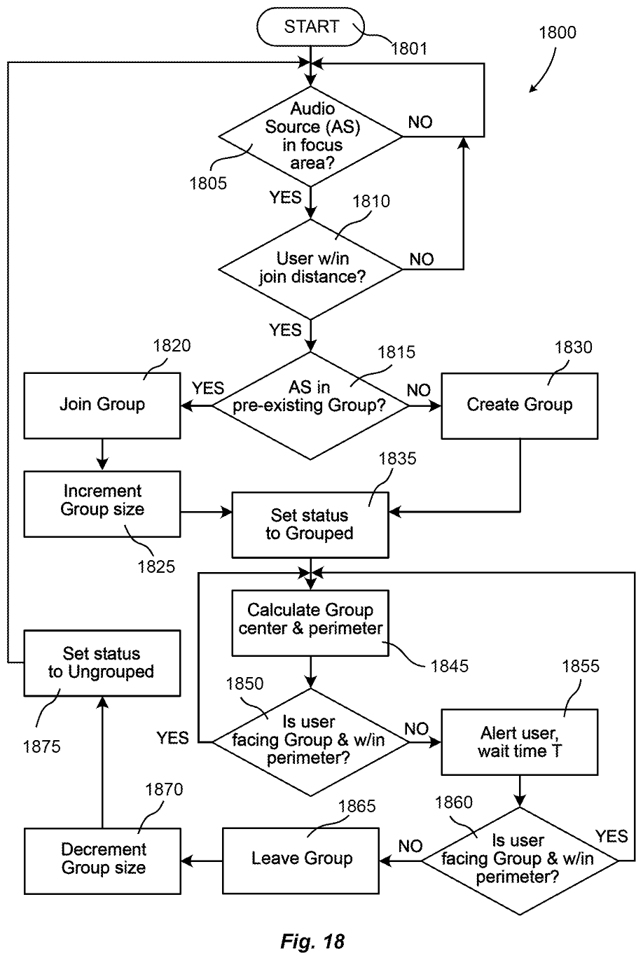

FIG. 18 provides an implementation of a grouping process 1800. In some implementations, the process 1800 starts at block 1801 when a user is not associated with a distinct group of audio sources, and therefore has a group status set to “Ungrouped” with all audio sources within the virtual environment 100 considered primary audio sources producing primary audio objects. The system queries in block 1805 weather an audio source is within a focus area of a user's avatar. In some implementations the focus area encompasses the entire field of view for an avatar at a given position and orientation. In some implementations an avatar's focus area is a portion of an avatar's field of view. For example, referring to FIG. 1B, in some implementations a user's field of view may be represented by wide field of view 182, and a focus area may be represented as a narrower subset of the field of view, such as the angle represented as field of view 184. If there is no audio source within the focus area, in some implementations the process loops at this block until there is an audio source. In some implementations the process 1800 ends if no audio sources within the focus area. If there is an audio source within the focus area then the system queries at block 1810 whether the user is within a joint distance defined by the audio source. If not the process can return to block 1805 in some implementations, and in some implementations the process can end. If the user's avatar is within a join distance, process queries at block 1815 whether the audio source is a member of a pre-existing group. If not the process at block 1830 creates a new group consisting of the user and the audio source, and then at block 1835 sets the user status to “Grouped.” This user Grouped status is associated with a unique group ID shared by each member of that distinct group, and is stored in user database 964 of storage unit 960 of virtual environment server 900 for use in other processes. In some implementations, member audio sources of the user's distinct group are considered primary audio sources providing primary audio, and audio sources from outside of the distinct group are considered secondary audio sources providing secondary audio objects. Primary audio objects are processed through the first sound processor 1021 as described above, and secondary sound objects are processed through second sound processor 1022 as described above.

If at query 1815 the audio source is currently a member of a pre-existing group, the user joins that group at block 1820, the group size of the preexisting group is incremented by 1, in the user status is set to Grouped as described above. Once grouped the process at block 1845 calculates a new group center based on the geometry of the group member positions, and calculates a group perimeter with a radius (or other perimeter geometry if, in some implementations, the perimeter is non-circular) based on the number (and in some implementations, the positions) of the group members.

The process 1800 then queries at block 1850 whether the user's avatar is facing at least one group member or the group center in its avatar's focus area, and whether the user's avatar has remained within the group perimeter as calculated at block 1845. If it is then the system process 1800 loops back to block 1845 to recalculate group center and perimeter at the next update interval of the process 1800, taking into account any new or departed or repositioned members of the group.

If the user has not maintained group requirements, the process can in some implementations alert the user through the user's virtual reality apparatus of the users group requirement deficiency at block 1855, where the process waits a time T before moving on to block 1860 where the process queries whether or not the user has returned to a state that is facing the group and within the group perimeter. If the user has reestablished group requirements then the process 1800 returns to block 1845 to recalculate group center and perimeter. If the user has not reestablished group requirements in the process moves to block 1865 removing the user from the group, the group sizes reduced by one at block 1870, user group status is set to “Ungrouped” at block 1875, and the process either returns to block 1805 to restart the process, or the process ends. In some implementations, when a user's group status is set to “Ungrouped,” all audio sources are considered primary audio sources providing primary audio objects.

To summarize, a user's experience within a virtual environment may be improved through the transformation of audio delivered to the user. Specifically, when a user would like to focus on audio coming from a preferred source, whether that source be another user, a group of users, or even a non-user audio source, the system can recognize the desired target, group the user with that audio source, and increase the legibility of the audio source by filtering the audio of the primary audio source, the secondary (non-primary) audio sources, or both. By doing so the user is better able to experience a virtual environment.

In some implementations, the features described herein technologically improves the virtual environment system by the use of directional vectors and dot product vector processing to rapidly assist audio processing thereby creating an enhanced audio experience for avatars interacting within the virtual environment. Virtual environment processing is computationally intensive. Previously, virtual environment processing lacked sufficient audio processing resources to facilitate the user's ability, via his avatar, to clearly discern virtual environment audio from primary and secondary sources. The systems and methods described herein, including the use of directional vectors and dot product vector processing greatly reduce computational loads for audio processing, thereby allowing computationally efficient avatar groupings (where primary audio sources are enhanced and secondary audio sources are diminished) and ungroupings, as the avatar moves within the virtual environment. This technological improvement greatly enhances a user's virtual environment experience.

Implementations described herein may be implemented in hardware, firmware, software, or any combination thereof. Implementations of the disclosure herein may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); hardware memory in handheld computers, PDAs, smart phones, and other portable devices; magnetic disk storage media; optical storage media; USB drives and other flash memory devices; Internet cloud storage, and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

Although method/process operations (e.g., blocks) may be described in a specific order, it should be understood that other housekeeping operations can be performed in between operations, or operations can be adjusted so that they occur at different times or can be distributed in a system which allows the occurrence of the processing operations at various intervals associated with the processing, as long as the processing of the overlay operations are performed in the desired way.

The present disclosure is not to be limited in terms of the particular implementations described in this disclosure, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations have been described. Various modifications may be made without departing from the spirit and scope of the disclosure. For example, various forms of the method/process flows shown above may be used, with operations or steps re-ordered, added, or removed. Accordingly, other implementations are within the scope of the following claims.

We claim:

1. A method of audio processing in a multi-user virtual environment having a plurality of audio sources, the method comprising the steps of:
determining a group status of a user;
receiving an audio object at the user;
classifying the received audio object as a primary audio object or a secondary audio object based upon the determined group status of the user;
processing the received audio object at a first sound processor if classified as a primary audio object and at a second sound processor if classified as a secondary audio object, wherein the first sound processor applies a first set of filters to audio objects processed therethrough, and the second sound processor applies a second set of filters to audio objects processed therethrough that are different from said first set of filters.

2. The method of claim 1, wherein the group status of a user can be either Grouped with a distinct group or Ungrouped, and the step of classifying classifies all received audio objects as primary audio objects when the group status is Ungrouped.

3. The method of claim 1, wherein the group status of a user can be either Grouped with a distinct group, or Ungrouped, and when the group status of the user is Grouped, the step of classifying classifies received audio objects as primary audio objects if the audio objects come from audio sources that are members of the distinct group of the user, and classifies received audio objects as a secondary audio objects if the audio objects do not come from audio sources that are members of the distinct group of the user.

4. The method of claim 1, wherein the step of determining further comprises the steps of:
identifying an audio source within a focus area of a visual scene of the virtual environment presented to the user;
evaluating a distance between a user's avatar within the virtual environment and the audio source within the virtual environment;
grouping with the audio source into a distinct group; and
setting a group status of the user to Grouped and associated with the distinct group.

5. The method of claim 4, wherein the step of identifying includes calculating a dot product of a facing vector directed toward a facing direction of a user's avatar, and a source vector in a direction from the user's avatar to the audio source.

6. The method of claim 4 further comprising the step of maintaining a Grouped status by:
calculating a common focal point at a geometric center of a plurality of members of a distinct group and a group perimeter encircling the plurality of members of the distinct group;
verifying that the user's avatar is facing either the geometric center of the distinct group or a member of the distinct group.

7. The method of claim 6 wherein verifying includes calculating a dot product of a facing vector directed toward a facing direction of the user's avatar, and a source vector in a direction from the user's avatar to the geometric center of the distinct group and each member of the distinct group.

8. A system for processing audio in a virtual environment comprising:
a virtual reality apparatus having a control unit, a sensory processing unit, and a non-transitory storage unit having instructions stored thereon that, when executed by the control unit and the sensory processing unit, causes the control unit and sensory processing unit to perform at least the following:
determining a group status of a user;
receiving an audio object at the user;
classifying the received audio object as a primary audio object or a secondary audio object based upon the determined group status of the user;
processing the received audio object at a first sound processor if classified as a primary audio object and at a second sound processor if classified as a secondary audio object, wherein the first sound processor applies a first set of filters to audio objects processed therethrough, and the second sound processor applies a second set of filters to audio objects processed therethrough that are different from said first set of filters.

9. A method of processing audio in a virtual environment comprising the steps of:
defining a group status of a user;
receiving group status and audio output data of an audio object coming from an audio source, wherein the audio output data includes default audio output parameters;
comparing object class data of the audio object with object class data of the user;
calculating, at a first sound processor with a first filter, filtered audio output parameters of the audio output data of audio objects having the same object class data as the user;
calculating, at a second sound processor with a second filter, filtered audio output parameters of the audio output data of audio objects not having the same object class data of the user; and
transmitting the audio output data with filtered audio output parameters to an audio output device.

10. The method of claim 9 wherein the step of defining includes the steps of:
identifying whether an audio source is within a focus area of the user;
determining whether the user is within a join distance of an audio source within the focus area of the user;
joining with the audio source into a primary group; and
altering the group status of the user to include a grouped status associated with the primary group.

11. The method of claim 9 wherein the default audio output parameters include a default volume level, and wherein the second filter produces filtered audio output parameters having a lowered volume level.
